(19) United States
(12) Patent Application Publication
(10) Pub. No.: US 2011/0080108 A1
(43) Pub. Date: Apr. 7, 2011

(54) Color tunable light emitting diode

(75) Inventors: Chung-I Chiang, Taoyuan (TW); Hung-Yi Lin, Taoyuan (TW); Hsien-Lung Ho, Taoyuan (TW)

(73) Assignee: WALSIN LIHWA CORPORATION, Taoyuan (TW)

(21) Appl. No.: 12/588,131

(22) Filed: Oct. 6, 2009

(51) Int. Cl. H05B 37/02

(52) U.S. Cl. 315/250; 315/294

(57) ABSTRACT

A color tunable light emitting diode is disclosed in the present invention. At least two light emitting chip groups each has a number of light emitting chips mixed with at least one phosphor to produce light with a specific correlated color temperature. By supplying tunable currents to the light emitting chip groups, properly arranging the light emitting chips and providing a suitable substrate, the color tunable light emitting diode can be achieved. The present invention provides a simple and workable method to manufacture tunable light emitting diodes which fulfill the requirement of compact design of modern electronic products.

### CROSS REFERENCE TO RELATED APPLICATIONS

The following co-pending US patent applications are incorporated herein by reference: US Pub. Nos. 2008/0017962A1, 2008/0017876A1, 2008/0017880A1, 2008/0017963A1, 2008/0191605A1, 2008/0194054A1, 2008/0197370A1, 2009/0032832A1, and 2008/0210963A1.

### FIELD OF THE INVENTION

The present invention relates generally to a light emitting diode. More specifically, the present invention relates to a tunable correlated color temperature light emitting diode.

### BACKGROUND OF THE INVENTION

With the decreasing sources of energy, people are urgently looking for alternative solutions to fulfill the increasing demands worldwide. One of the demands comes from lightening. Therefore, providing economical lightening devices or saving power consumption is a hot topic among these business entities in this field. Light Emitting Diode (LED) is a potential product for people to find out answers. LEDs have advantages of small size, long working life, low power consumption, etc. As to applicability, white light LEDs play the key role.

White light LEDs are widely used as backlight for mobile phones and liquid crystal displays. They can also be used as a lamp for lightening. However, there is no simple way to produce a LED generating pure white light. White light emitted from LED can be achieved by combination of different light sources or using phosphors. Please refer to FIG. 1A to FIG. 1C. Three conventional methods to get white light with LEDs are provided. As shown in FIG. 1A. A green, blue and red LEDs are put very close to one another and emit light. The combination of green, blue and red light covers most of visible light spectrum as if it were “white light”, but there are some defects. First, since three LEDs are very close in space, circuit layout is difficult. Besides, red LEDs suffer from decay more seriously than blue and green LEDs. That is to say, if a specific light having a small range of correlated color temperature (CCT) has to keep emitting, the red LED needs to be adjusted often. It is not convenient for product users to do so. An alternative method to tune red LED is using feedback control to adjust the current flowing into it. However, it is still troublesome and increases cost of white light LEDs.

A second way to provide white light is to use blue LED and a kind of yellow phosphor. Please see FIG. 1B. A white light LED is made by covering a blue light emitting chip with yellow phosphor and epoxy resin. Light from the blue LED excites the phosphor to generate an excited light. Spectrum of the excited light covers the rest of visible light portion that blue light doesn't have. Therefore, the combined light seems a white light. The light is not exact white since some wavelengths are not what people sense from daylight. The method is simple in manufacturing and has good color rendering, excellent stability and reliability. However, due to the deviation during packaging process and variation of phosphors, performance of the LEDs compared to the ideal light shows a Gaussian distribution for the same batch of LEDs manufactured. Hence, yield rate of LEDs is low. Heat generated affects phosphor, too. An alternative is to package a red light emitting chip with the blue LED to solve the problem of variation of phosphors, but red light emitting chips have a problem of decay so that workability is limited.

Similarly, a third conventional method shown in FIG. 1C utilizes a blue LED and multiple phosphors. The combined light of each light excited from the phosphors and the blue LED light also covers the visible light spectrum. The method provides stable white light with better color rendering compared to the second method. Nevertheless, stability and reliability are not that good since red phosphor is not stable and decays with time. That leaves room for improvement.

If a decayed LED or a LED with decayed phosphor can be tuned, a desirable light is obtained as time goes by. Moreover, the way to achieve the desirable light is able to provide customized light sources. A prior art was proposed in US Patent Pub. No. 2008/0278927A1. Please refer to FIG. 2A and FIG. 2B. A color tunable light source 1 forms an array of LED arrangements 2 and 3. The LED arrangement 2 has LED 9 which generates excitation energy 11 to a region of phosphor material 7 to irradiate light 13. Combination of the excitation energy 11 and irradiated light 13 forms combined light 4. Similarly, the LED arrangement 3 has LED 10 which generates excitation energy 12 to a region of phosphor material 8 to irradiate light 14. Combination of the excitation energy 12 and irradiated light 14 forms combined light 5. A light output 6 is seen as a white light.

If the tunable light source 1 shows light with color deviated from a specific color (for example, it is a little reddish compared with the specific correlated color temperature), an adjustment can be done by changing currents provided to each LED arrangement 2, 3. It reveals an easy tuning method for LEDs. However, in practice, LED arrangements to show a specific color is not limited to two. Arrangement itself also plays an important role to CCT displayed. Moreover, installation of current supply device needs to be available in a compact solution. These are the challenges that '927 can't solve. However, with a proper package process and a substrate, plus a better LED arrangement, the problems mentioned above can be easily solved.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

In accordance with an aspect of the present invention, a color tunable light emitting diode comprises: a substrate; at least two light emitting chip groups, each emitting a correlated color temperature light and comprising: a plurality of light emitting chips for outputting a specific light, formed on the substrate; and at least one phosphor for generating an excited light by excitation of the specific light, attached to the light emitting chips by a fixing agent, wherein the correlated color temperature lights is a mixture of the specific light and the excited light; and a control circuit connected to the light emitting chip groups for supplying tunable currents to the light emitting chip groups respectively to provide a tunable light by combining the correlated color temperature light from the light emitting chip groups.

Preferably, the substrate is a silicon substrate, a ceramic substrate or a printed circuit board.

Preferably, the substrate is a cavity substrate or a flat substrate.

Preferably, the tunable currents each has a fixed magnitude for each of the light emitting chip groups.

Preferably, the tunable currents each has a periodical change in magnitude for each of the light emitting groups to change correlated color temperature of the specific light.

Preferably, the periodical change is controlled by a duty cycle of the tunable current flowing therethrough by means of pulse width modulation (PWM).

Preferably, the fixing agent is silicone.

Preferably, the light emitting chip groups are arranged as a 2-dimensional array with a periodically alternating sequence of the light emitting chips of each light emitting group in any row or column of the array.

Preferably, the light emitting chip groups form a plurality of 2-dimensional patterns.

Preferably, the control circuit is formed on the substrate.

Preferably, the control circuit is in form of a die bonded on the substrate.

Preferably, the control circuit is in form of an integrated circuit on the substrate.

Further in accordance with the other aspect of the present invention, a method of generating desirable light, comprises the steps of: a) attaching at least one phosphor onto a plurality of light emitting chips; b) emitting a specific light by each of the light emitting chips; c) exciting the phosphor by the specific light from the light emitting chip to generate an excited light; d) mixing the specific light of each of the light emitting chips and the excited light to form a correlated color temperature light; and e) supplying tunable currents to each of the light emitting chips to provide a tunable light by combining the correlated color temperature lights of each of the light emitting chips.

Preferably, the tunable currents each have a fixed magnitude for each of the light emitting groups.

Preferably, the tunable currents each has a periodical change in magnitude for each of the light emitting groups to change correlated color temperature of the specific light.

Preferably, the periodical change is controlled by a duty cycle of the tunable current flowing therethrough by means of pulse width modulation (PWM).

Preferably, step a) uses silicone to attach the phosphor.

Preferably, the light emitting groups are arranged as a 2-dimensional array with a periodically alternating sequence of the light emitting chips of each light emitting group in any row or column of the array.

Preferably, the light emitting groups form a plurality of 2-dimensional patterns.

Preferably, the method further comprising step a1) providing a substrate to support the light emitting chips.

Preferably, the substrate is a silicon substrate, a ceramic substrate or a printed circuit board.

Preferably, the substrate is a cavity substrate or a flat substrate.

Preferably, the tunable currents are provided by a control circuit in form of a die mounted on the substrate.

Preferably, the tunable currents are provided by a control circuit in form of an integrated circuit on the substrate.

### BRIEF DESCRIPTION OF THE DRAWINGS

FIG. 1A illustrates a prior art for producing white light with a green, blue and red light emitting diodes.

FIG. 1B illustrates another prior art for producing white light by covering a blue light emitting chip with yellow phosphor and epoxy resin.

FIG. 1C illustrates yet another prior art for producing white light by utilizing a blue LED and multiple phosphors.

FIG. 2A shows a prior arrangement of LEDs.

FIG. 2B details the structures of LED arrangements in FIG. 2A.

FIG. 3 illustrates a first embodiment of the present invention.

FIG. 4A illustrates the composition of a first light emitting unit in the first embodiment.

FIG. 4B is a CIE 1931 color space chromaticity diagram for the first embodiment.

FIG. 5 is a CIE 1931 color space chromaticity diagram for a second embodiment.

FIG. 6 illustrates the second embodiment of the present invention.

FIG. 7A illustrates the composition of the first light emitting unit in the second embodiment.

FIG. 7B illustrates the composition of the second light emitting unit in the second embodiment.

FIG. 8 shows duty cycles of currents for two light emitting groups in the second embodiment.

FIG. 9 is a CIE 1931 color space chromaticity diagram for a third embodiment.

FIG. 10 illustrates the third embodiment of the present invention.

FIG. 11A illustrates the composition of the first light emitting unit in the third embodiment.

FIG. 11B illustrates the composition of the second light emitting unit in the third embodiment.

FIG. 11C illustrates the composition of the third light emitting unit in the third embodiment.

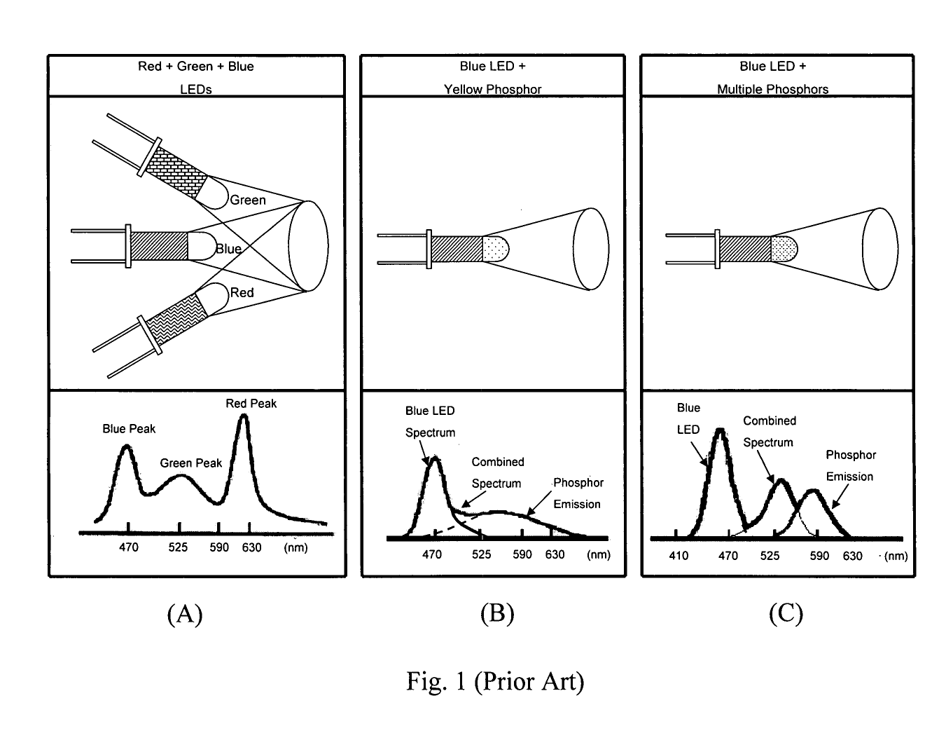

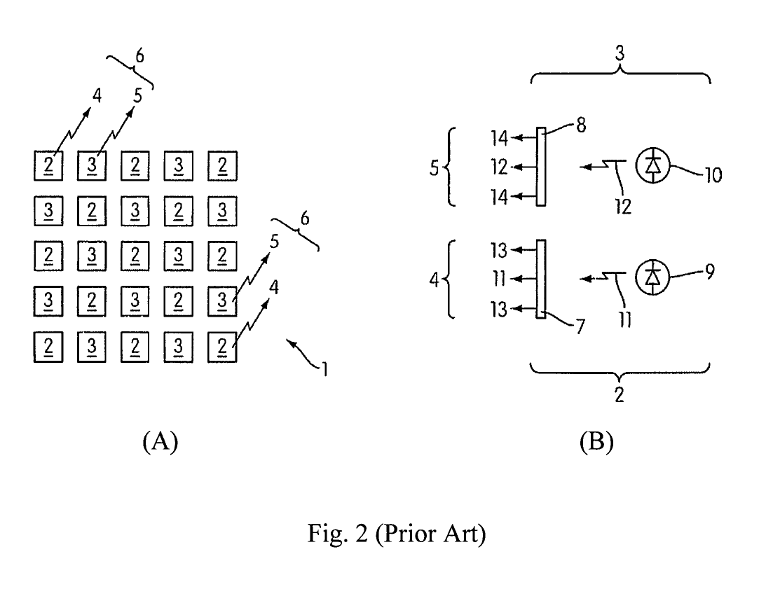

### DETAILED DESCRIPTION OF THE PREFERRED EMBODIMENTS

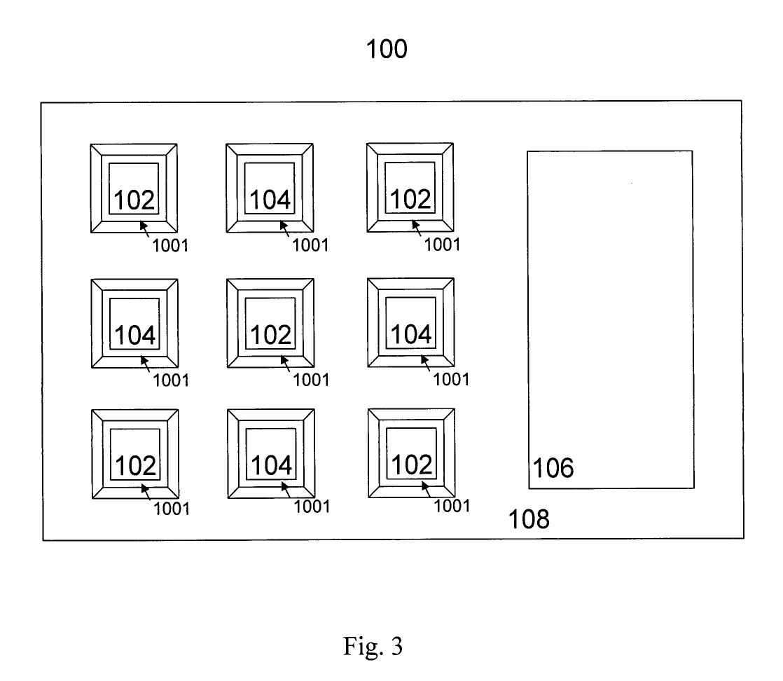

Please refer to FIG. 3. A first embodiment is illustrated. According to the present invention, a color tunable light emitting diode 100 comprises five first light emitting units 102, four second light emitting units 104, a control circuit die 106 and a ceramic substrate 108. The control circuit die 106 is bonded on the ceramic substrate 108 to supply tunable currents to the first light emitting units 102 and the second emitting units 104. The five first light emitting units 102 form a first light emitting group and link to the control circuit die 106 by bonding wires (not shown). The four second light emitting units 104 form a second light emitting group and link to the control circuit die 106 by other bonding wires (not shown). There are nine cavities 1001 in an array on the ceramic substrate 108. The array has three rows and three columns and is 2-dimensional on the surface of the ceramic substrate 108. Each of the cavities 1001 is used to support and fix one first light emitting unit 102 or one second light emitting unit 104. The spacing between adjacent two light emitting units is shorter than 1 mm. The first light emitting unit 102 and the second light emitting unit 104 are arranged in a periodically alternating sequence in any row or column of the array. That is to say, arrangement of light emitting units in any row or column of the array is one first light emitting unit 102 following one second light emitting unit 104, vice versa.

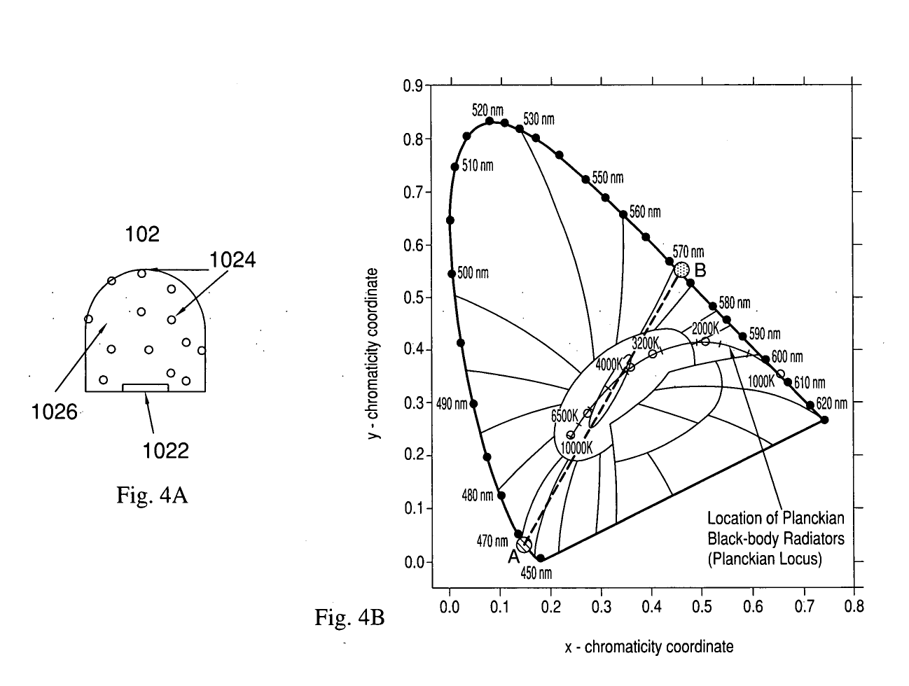

A detailed illustration of the first light emitting unit 102 is presented in FIG. 4A. The first light emitting unit 102 has a light emitting chip 1022 and a plurality of phosphors 1024. The phosphor 1024 is attached to the light emitting chip 1022 by a silicone 1026. The light emitting chip 1022 generates a visible blue light with peak light intensity having wavelength around 460 nm on the spectrum. The phosphor 1024 is able to emit a yellow light with peak light intensity having wavelength around 574 nm on the spectrum by excitation of the light from the light emitting chip 1022. The combined light from the light emitting chip 1022 and the phosphor 1024 seems white to human eyes since it covers the visible light spectrum.

Please refer to FIG. 4B. It is a CIE (International Commission on Illumination) 1931 color space chromaticity diagram and used to show how the light emitting chip 1022 works with phosphor 1024. Any visible color can be found on the diagram with an x chromaticity value and a y chromaticity value. Colors can be defined by the correlated color temperature (CCT). In the first embodiment, light color of the light emitting chip 1022 is shown at point A and light color of the excited phosphor 1024 is shown at point B. In practice, all color light on a dashed line linking point A and point B can be produced by adjusting the current provided to the light emitting chip 1022. For general use, a white light should have CCT falling within the elliptical area of FIG. 4B.

The structure of the second light emitting unit 104 is the same as that of the first light emitting unit 102. The second light emitting unit 104 has the light emitting chip 1022 and the plurality of phosphors 1024 which are attached to the light emitting chip 1022 by a silicone 1026. Technically, the light emitting chip 1022 and the second light emitting unit 104 come from the same batch of production. The difference between the first light emitting unit 102 and the second light emitting unit 104 is emitted CCT light and resulted from deviation during attaching process. The particles of the phosphors 1024 are mixed with the silicone 1026 before attaching. However, uniformity of mixture varies. After sorting of the manufactured light emitting chips, the first light emitting unit 102 can generate light with CCT of 5000K and the second emitting unit 104 can generate light with CCT of 6500K under current supply of 20 mA. In order to have a uniform light with CCT of 5200K, the control circuit die 106 provides 8 mA to the first light emitting units 102 and 12 mA to the second emitting unit 104 respectively. Currents are fixed in magnitude all the time. The first embodiment is a utilization of the present invention to solve the problem of quality of light emitting units.

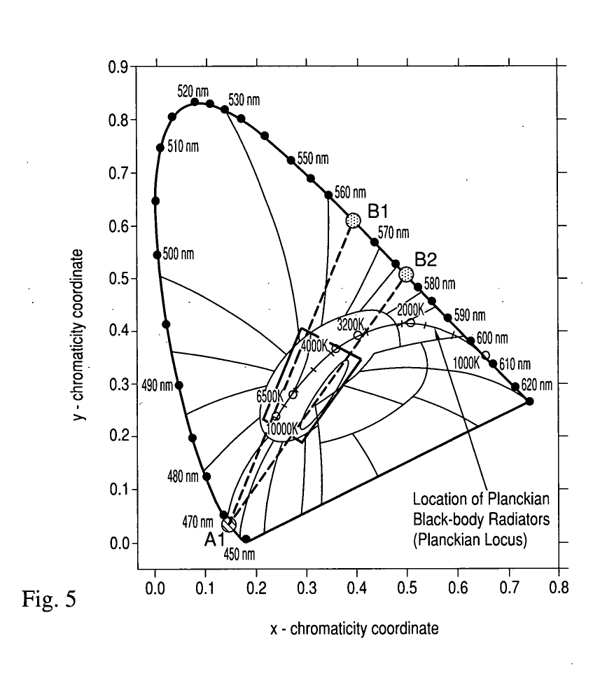

A second embodiment according to the present invention is described hereinafter with reference to FIGS. 5-8. In a more general situation, one light emitting chip can be combined with different phosphors to produce different color light. Please refer to FIG. 5. Point A1 represents a light emitting chip having specific blue light. Points B1 and B2 stand for two different phosphors. Each of the phosphors emits a specific excited yellow light by excitation of the blue light from the light emitting chip. Similarly, the combination of light emitting units of different phosphors contributes a variety of color light which falls in the bold-lined quadrangle of FIG. 5.

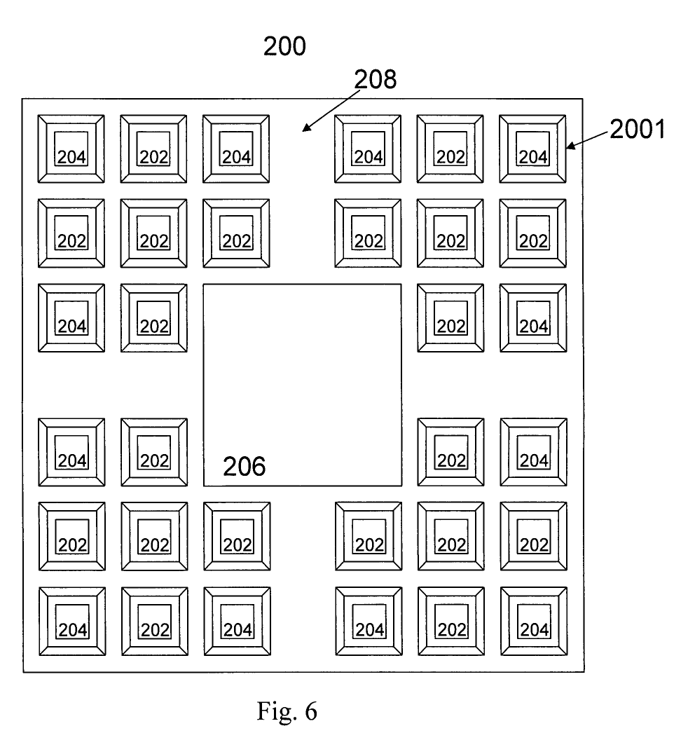

Please refer to FIG. 6. A color tunable light emitting diode 200 comprises twenty first light emitting units 202, twelve second light emitting units 204, a control circuit 206 and a silicon substrate 208. The silicon substrate 208 can be an optical package substrate (OPS). Furthermore, the silicon substrate 208 can include cavities for accommodating the first light emitting units 202 and the second light emitting units 204. However, the silicon substrate 208 is not limited to have cavities for accommodation of light emitting units. In practice, the silicon substrate 208 can also be a substrate having a flat surface. In other words, while the silicon substrate 208 has a flat surface, the light emitting units may directly be disposed in an array on top of the flat surface of the silicon substrate 208. By micro-electro-mechanical technology, such as making cavity for dice or wiring, circuit layout (not shown) for connecting each light emitting unit can be formed on the silicon substrate 208. The twenty first light emitting units 202 form a first light emitting group and link to the control circuit 206 via the circuit layout. The twelve second light emitting units 204 form a second light emitting group and link to the control circuit die 206 via the circuit layout. There are total thirty-two cavities 2001 formed on the silicon substrate 208. Compared with the first embodiment, arrangement of cavities 2001 is not an array. On the contrary, it has a plurality of 2-dimensional patterns. More specifically, each pattern is similar to one another in shape and composition but different in the spatial orientation. Each of the cavities 2001 is used to support and fix one first light emitting unit 202 or one second light emitting unit 204. The spacing between adjacent two light emitting units is shorter than 1 mm. The control circuit 206 is for supplying tunable currents to the first light emitting units 202 and the second emitting units 204.

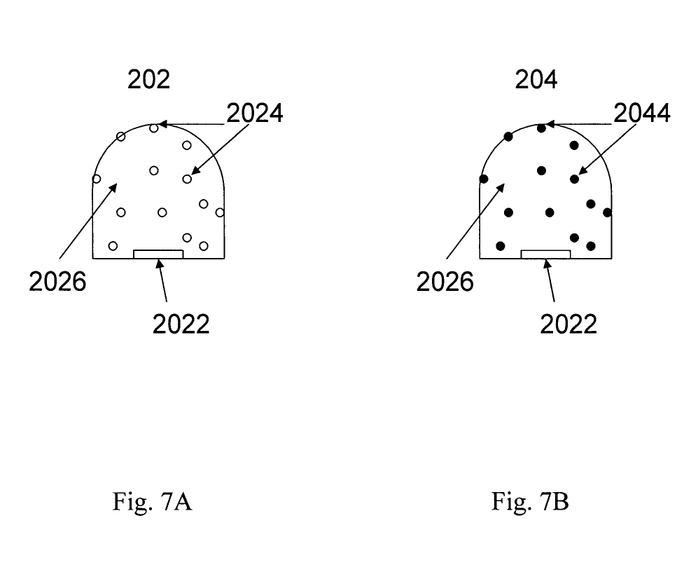

FIG. 7A shows the composition of the first light emitting unit 202. The first light emitting unit 202 has a light emitting chip 2022 and a plurality of first phosphors 2024. The first phosphor 2024 is attached to the light emitting chip 2022 by a silicone 2026. The light emitting chip 2022 generates a visible blue light with peak light intensity having wavelength around 460 nm on the spectrum. The first phosphor 2024 is able to emit a yellow light with peak light intensity having wavelength around 564 nm on the spectrum by excitation of the light from the light emitting chip 2022. The combined light from the light emitting chip 2022 and the first phosphor 2024 seems white to human eyes since it covers the visible light spectrum. Please refer to FIG. 7B. The composition of the second light emitting unit 204 comprises a light emitting chip 2022 and a plurality of second phosphors 2044. The second phosphor 2044 is attached to the light emitting chip 2022 by a silicone 2026. The second phosphor 2044 is able to emit a yellow light with peak light intensity having wavelength around 578 nm on the spectrum by excitation of the light from the light emitting chip 2022.

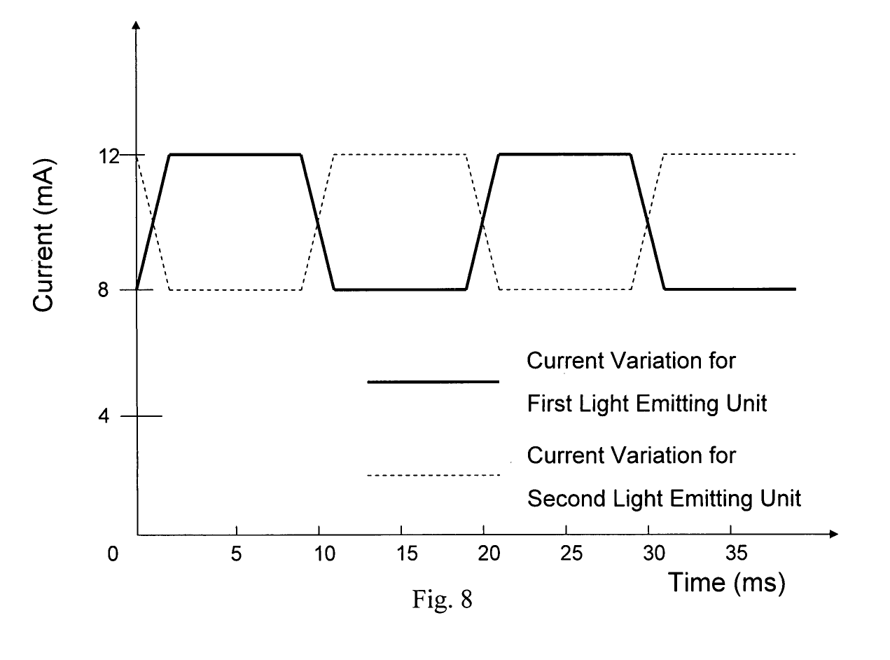

The first light emitting unit 202 can generate light with CCT of 6500K and the second emitting unit 204 can generate light with CCT of 5000K under current supply of 20 mA. In order to have a uniform light with CCT of 5200K, the control circuit 206 provides periodically changed currents to the first light emitting units 202 and the second emitting unit 204 respectively. Currents are generated from a pulse width modulator designed in the control circuit 206. Duty cycles of currents for two light emitting groups are shown in FIG. 8. Since there are two magnitudes of current (8 mA and 12 mA) alternatively changed for each light emitting unit, the color tunable light emitting diode 200 actually provides a blinking light source. The light from each light emitting unit is white light and people can not perceive blinking phenomenon. A uniform light with CCT of 5200K can be achieved in this way.

It should be noted that the patterns mentioned in the second embodiment should not be limited to the same shape and composition. One pattern can be totally different from another in shape and design. Meanwhile, patterns can be continuously or discontinuously arranged on a silicon substrate. Most of all, the pattern itself can be randomly designed as long as the lightening effect is satisfactory.

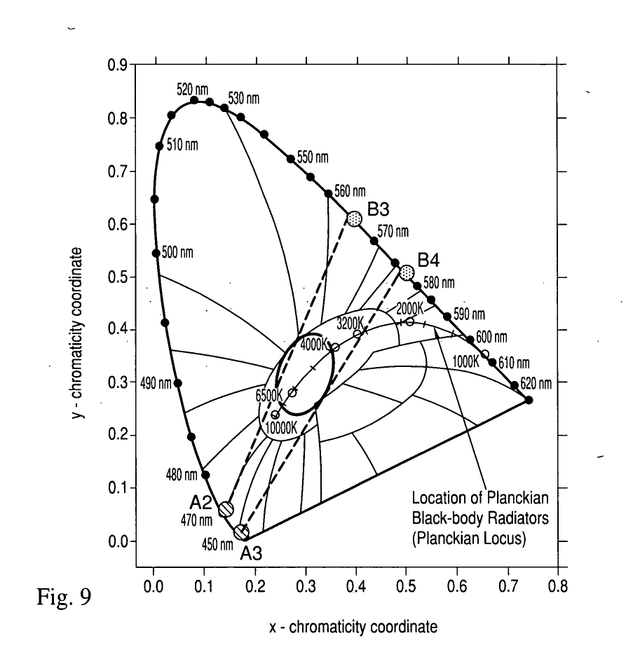

Design of light emitting unit is not restricted to use only one kind of light emitting chips. A mixture of two or more than two light emitting chips is commonly seen for manufacturing light emitting diodes. The effect of mixture of two groups of light emitting chips can have light spectrum covering the bold elliptical area in FIG. 9 by changing current. As shown in FIG. 9, the dash line A2-B3 and dash line A3-B4 represent two light emitting units with different light emitting chips and phosphors.

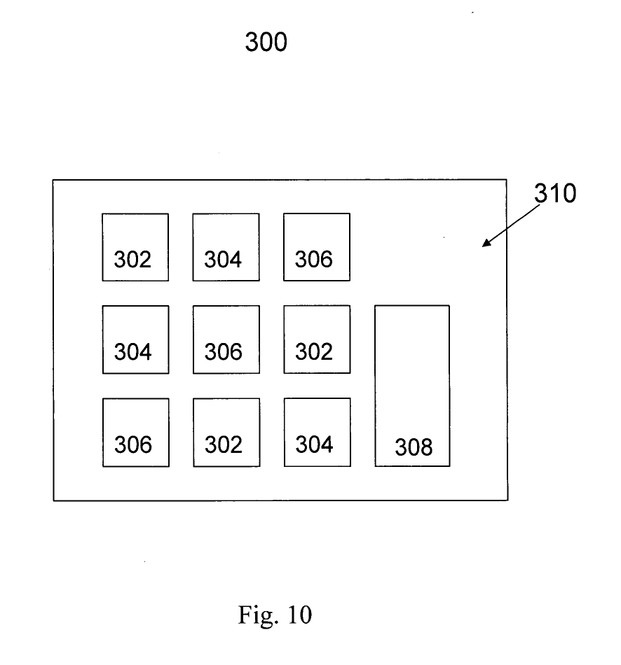

In a third embodiment, a combination using multiple light emitting chips is disclosed. Please see FIG. 10. A color tunable light emitting diode 300 comprises three first light emitting units 302, three second light emitting units 304, three third light emitting units 306, a control circuit die 308 and a printed circuit board (PCB) 310. The control circuit die 308 is bonded on the printed circuit board 310 to supply tunable currents to the first light emitting units 302, the second light emitting units 304 and the third emitting units 306. The three first light emitting units 302 form a first light emitting group and link to the control circuit die 308 via the printed circuit board 310. The three second light emitting units 304 form a second light emitting group and link to the control circuit die 308 via the printed circuit board 310. The three third light emitting units 306 form a third light emitting group and link to the control circuit die 308 via the printed circuit board 310. Arrangement of the light emitting groups forms an array. The array has three rows and three columns and is 2-dimensional on the surface of the printed circuit board 310. The three kinds of emitting units are arranged in a periodically alternating sequence and each one appears once in any row or column of the array.

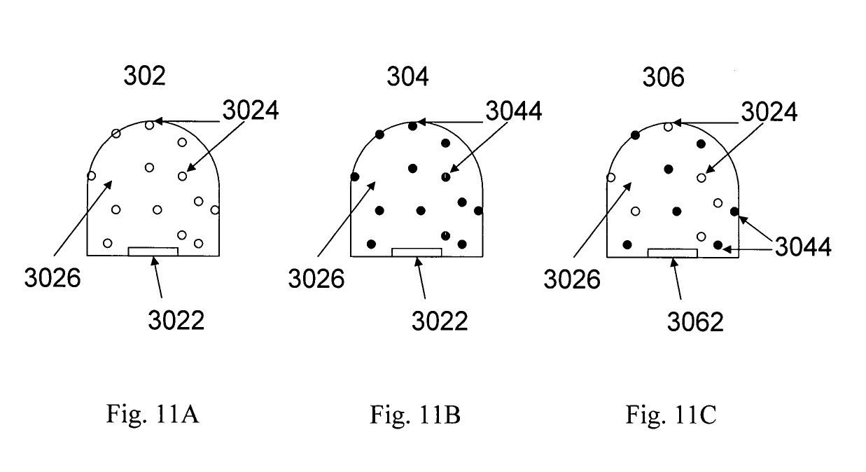

A detailed illustration of the first light emitting unit 302 is presented in FIG. 11A. The first light emitting unit 302 has a first light emitting chip 3022 and a plurality of first phosphors 3024. The first phosphor 3024 is attached to the first light emitting chip 3022 by silicone 3026. The first light emitting chip 3022 generates visible blue light with peak light intensity having wavelength around 460 nm on the spectrum. The first phosphor 3024 is able to emit yellow light with peak light intensity having wavelength around 564 nm on the spectrum by excitation of the light from the first light emitting chip 3022. A first combined light from the first light emitting chip 3022 and the first phosphor 3024 seems white to human eyes since it covers the visible light spectrum. The CCT of the first combined light is 5000K. Please refer to FIG. 11B. The second light emitting unit 304 has a first light emitting chip 3022 and a plurality of second phosphors 3044. The second phosphor 3044 is attached to the first light emitting chip 3022 by the silicone 3026. The second phosphor 3044 is able to emit yellow light with peak light intensity having wavelength around 578 nm on the spectrum by excitation of the light from the first light emitting chip 3022. A combined light from the first light emitting chip 3022 and the second phosphor 3044 is also white light but has 6500K CCT.

Please refer to FIG. 11C. The third light emitting unit 306 has a second light emitting chip 3062 and a plurality of first phosphors 3024 and second phosphors 3044. The first phosphors 3024 and second phosphors 3044 are attached to the second light emitting chip 3062 by the silicone 3026. The second light emitting chip 3062 generates visible blue light with peak light intensity having wavelength around 450 nm on the spectrum. A third combined light from the first light emitting chip 3062, the first phosphors 3024 the second phosphors 3044 is white light with 6000K CCT.

In order to have a uniform light with CCT of 5500K, the control circuit die 308 provides 8 mA current to every light emitting unit. Currents keep a fixed magnitude. The third embodiment shows that even the current has no deviation in all groups, a desirable light can be generated by arranging three kinds of light emitting units with a single current. It should be noted that the present invention emphasizes currents which can be tuned to have a fixed value. In the third embodiment, the PCB 310 can be replaced with a ceramic substrate with bonding wires for electrical connection. The kinds of light emitting chips can be more than two. Of course, the combination of light emitting units has a great diversity.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A color tunable light emitting diode comprising:
a substrate;
at least two light emitting chip groups, each emitting a correlated color temperature light and comprising:
a plurality of light emitting chips for outputting a specific light, formed on the substrate; and
at least one phosphor for generating an excited light by excitation of the specific light, attached to the light emitting chips by a fixing agent, wherein the correlated color temperature light is a mixture of the specific light and the excited light; and
a control circuit connected to the light emitting chip groups for supplying tunable currents to the light emitting chip groups respectively to provide a tunable light by combining the correlated color temperature lights from the light emitting chip groups.

2. The light emitting diode according to claim 1, wherein the substrate is a silicon substrate, a ceramic substrate or a printed circuit board.

3. The light emitting diode according to claim 1, wherein the substrate is a cavity substrate or a flat substrate.

4. The light emitting diode according to claim 1, wherein the tunable currents each has a fixed magnitude for each of the light emitting chip groups.

5. The light emitting diode according to claim 1, wherein the tunable currents each has a periodical change in magnitude for each of the light emitting groups to change correlated color temperature of the specific light.

6. The light emitting diode according to claim 5, wherein the periodical change is controlled by a duty cycle of the tunable current flowing therethrough by means of pulse width modulation (PWM).

7. The light emitting diode according to claim 1, wherein the fixing agent is silicone.

8. The light emitting diode according to claim 1, wherein the light emitting chip groups are arranged as a 2-dimensional array with a periodically alternating sequence of the light emitting chips of each light emitting group in any row or column of the array.

9. The light emitting diode according to claim 1, wherein the light emitting chip groups form a plurality of 2-dimensional patterns.

10. The light emitting diode according to claim 1, wherein the control circuit is formed on the substrate.

11. The light emitting diode according to claim 1, wherein the control circuit is in form of a die bonded on the substrate.

12. The light emitting diode according to claim 1, wherein the control circuit is in form of an integrated circuit on the substrate.

13. A method of generating desirable light, comprising the steps of:
a) attaching at least one phosphor onto a plurality of light emitting chips;
b) emitting a specific light by each of the light emitting chips;
c) exciting the phosphor by the specific light from the light emitting chip to generate an excited light;
d) mixing the specific light of each of the light emitting chips and the excited light to form a correlated color temperature light; and
e) supplying tunable currents to each of the light emitting chips to provide a tunable light by combining the correlated color temperature lights of each of the light emitting chips.

14. The method according to claim 13, wherein the tunable currents each has a fixed magnitude for each of the light emitting groups.

15. The method according to claim 13, wherein the tunable currents each has a periodical change in magnitude for each of the light emitting groups to change correlated color temperature of the specific light.

16. The method according to claim 15, the periodical change is controlled by a duty cycle of the tunable current flowing therethrough by means of pulse width modulation (PWM).

17. The method according to claim 13, wherein step a) uses silicone to attach the phosphor.

18. The method according to claim 13, wherein the light emitting groups are arranged as a 2-dimensional array with a periodically alternating sequence of the light emitting chips of each light emitting group in any row or column of the array.

19. The method according to claim 13, wherein the light emitting groups form a plurality of 2-dimensional patterns.

20. The method according to claim 13, further comprising step a1) of providing a substrate to support the light emitting chips.

21. The method according to claim 20, wherein the substrate is a silicon substrate, a ceramic substrate or a printed circuit board.

22. The method according to claim 20, wherein the substrate is a cavity substrate or a plate substrate.

23. The method according to claim 20, wherein the tunable currents are provided by a control circuit in form of a die mounted on the substrate.

24. The method according to claim 20, wherein the tunable currents are provided by a control circuit in form of an integrated circuit on the substrate.
